(19) United States
(12) Patent Application Publication
(10) Pub. No.: US 2025/0328334 A1
(43) Pub. Date: Oct. 23, 2025

(54) MACHINE LEARNING-BASED SOFTWARE PATCH RECOMMENDATIONS

(71) Applicant: SAP SE, Walldorf (DE)

(72) Inventors: James Odendal, Munich (DE); Matthias Bellm, Hambrücken (DE); Andreas Vogel, Rauenberg (DE); Rafael Luedtke, Karlsruhe (DE); Haolong Yan, Uhldingen-Mühlhofen (DE); Jan Schulte-Rebbelmund, Heidelberg (DE)

(21) Appl. No.: 18/642,956

(22) Filed: Apr. 23, 2024

(51) Int. Cl. G06F 8/65; G06N 20/00

(52) U.S. Cl. CPC G06F 8/65; G06N 20/00

(57) ABSTRACT

Disclosed herein are a system, method, and computer program product embodiments for recommending software patch notification(s) to computing system(s). For example, a representation of a notification indicating that a software patch configured to update a particular software component is available for installation is provided as an input to a machine learning model. The machine learning model is configured to predict a particular computing system, of a plurality of computing systems on which the particular software component is installed, that is to receive the software patch. A prediction is received from the machine learning model. The prediction indicates that at least one computing system of the plurality of computing systems is to receive the software patch. A recommendation to apply the software patch on the at least one computing system is provided.

### BACKGROUND

Hundreds of software patch notifications are generated for software product portfolios on a daily basis. These notifications contain potentially valuable information for customers, helping them to fix incidents, fix bugs, prevent issues, optimize their systems, or harness new features. The notifications may contain code corrections and are used to fix errors, ship small enhancements and legal changes to customers.

However, the sheer volume and variety of these notifications present significant challenges. It is difficult to identify and recommend the most relevant and beneficial recommendation for a specific customer system. This task becomes even more complex given the diverse range of components of a given software product portfolio, which necessitates a broad spectrum of domain knowledge. An issue arises when attempting to efficiently navigate this information overload, and accurately linking each customer system with the most relevant notifications.

### BRIEF DESCRIPTION OF THE DRAWINGS

The accompanying drawings are incorporated herein and form a part of the specification.

FIG. 1 is a block diagram of a system for recommending software patch notifications, according to some embodiments.

FIGS. 2A-2B depict example clusters of software patch notifications, according to some embodiments.

FIG. 3 is a flowchart of a method for recommending a software patch notification for a computing system, according to some embodiments.

FIG. 4 is a flowchart for a method for generating a machine learning model, according to some embodiments.

FIG. 5 is an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

As discussed in the Background Section above, the sheer volume and variety of software patch notifications present significant challenges. It is difficult to identify and recommend the most relevant and beneficial recommendation for a specific customer system. Moreover, customers face the challenge that thousands of notifications are technically valid for each of their systems, but irrelevant from a business point of view. Given the business context of a particular system, only a subset of notifications may be relevant and applied. Identifying these notifications will save time and compute resources and can help to avoid error situations proactively.

The embodiments described herein address the aforementioned problems via an implementation that can effectively analyze newly-released notifications, understand the context of the notification and each customer's system, and provide tailored recommendations that are most likely to assist each customer. Such techniques may leverage data processing and machine learning techniques to achieve this purpose, thereby automating a complex task and delivering more value to the customer base.

In particular, provided herein are system, method and/or computer program product embodiments, and/or combinations and sub-combinations thereof, for recommending software patch(es) to computing system(s). For example, a representation of a notification indicating that a software patch configured to update a particular software component is available for installation is provided as an input to a machine learning model. The machine learning model is configured to predict a particular computing system, of a plurality of computing systems on which the particular software component is installed, that is to receive the software patch. A prediction is received from the machine learning model. The prediction indicates that at least one computing system of the plurality of computing systems is to receive the software patch. A recommendation to apply the software patch on the at least one computing system is provided.

The techniques described herein improve the functioning of a computing system. For example, because the most relevant software patches are recommended to the computing system, the computing system is no longer bombarded with hundreds or even thousands of notifications (some of which that are not even applicable to the computing system). This advantageously conserves the network bandwidth of the computing device, as a lesser amount of notifications are provided to the computing system. Moreover, the recommended software patches are more likely to be applied in a timely fashion. By applying such patches, various issues (e.g., usability issues, performance issues, etc.) of the computing system are remedied, thereby enabling the computing system run more efficiently. Accordingly, various compute resources (e.g., processor cycles, memory, storage, etc.) that are normally consumed from defective software are conserved as a result of timely applying such software patches.

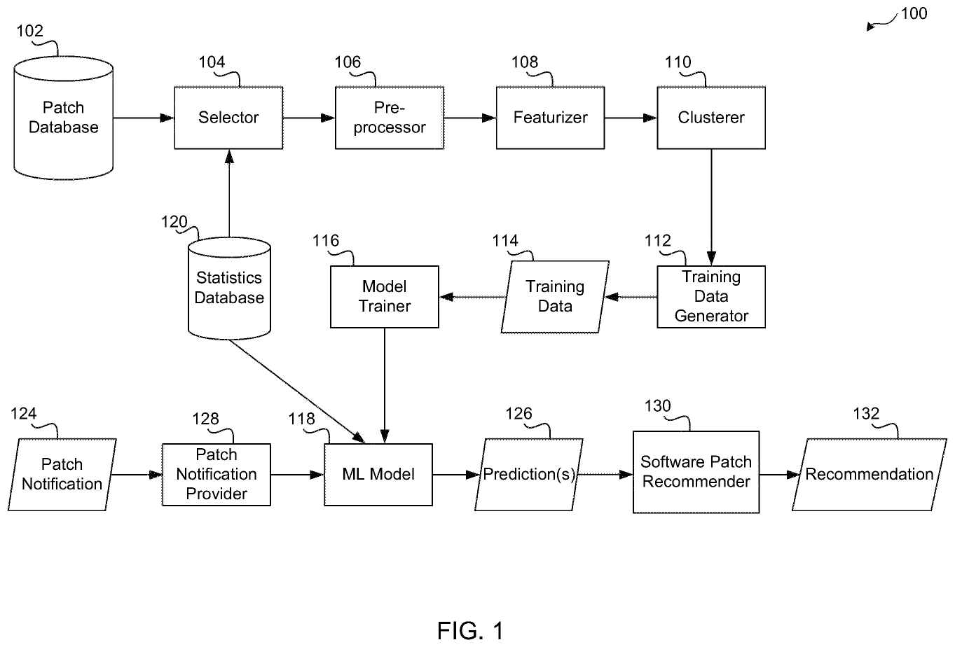

FIG. 1 is a block diagram of a system 100 for recommending software patch notifications, according to some embodiments. As shown in FIG. 1, system 100 includes a software patch database 102, a selector 104, a pre-processor 106, a featurizer 108, a clusterer 110, a training data generator 112, a machine learning (ML) model trainer 116, an ML model 118, a statistics database 120, a patch notification provider 128, and a software patch recommender 130. Each of these elements will now be described.

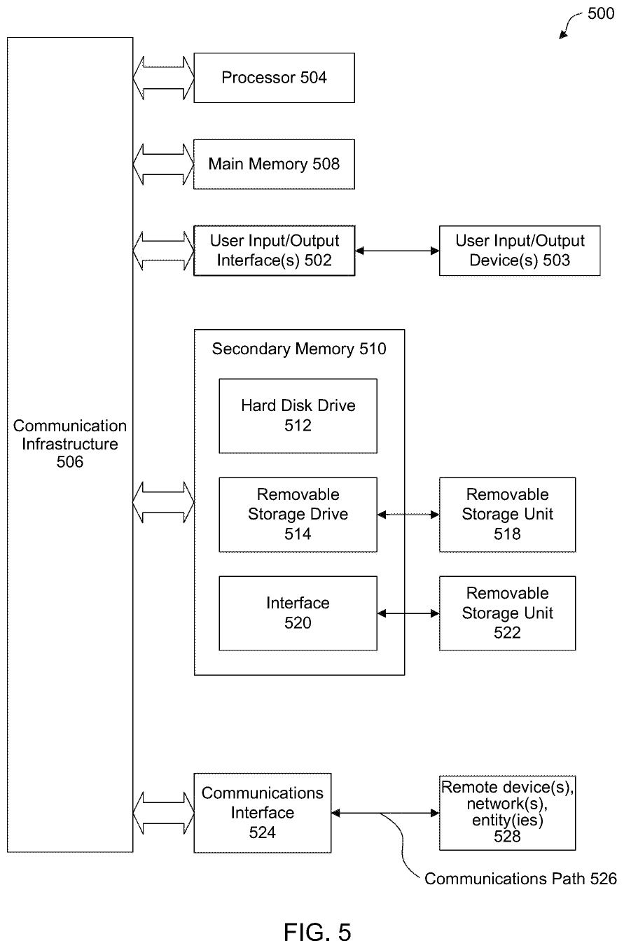

Patch database 102 is intended to represent one or more databases that store various software patches (or software updates) configured to update various software programs (or components thereof) and/or an operating system executing one or more computing systems. Examples of software components include, but are not limited to, services, plug-ins, application programming interfaces (APIs), libraries, etc. Software patches may be configured to address security vulnerabilities, address performance issues, implement bug fixes, add and/or remove certain functionality, etc. In one example, patches may be in the form of executable files. In another example, patches may comprise a set of instructions to be performed by a user. Patch database 102 may also store notifications indicating that particular software patches are available for installation. Examples of such notifications and patches include, but are not limited to SAP® Notes, SAP® Security Notes, or various knowledge-based articles (KBAs). Patch database 102 may be stored, for example, in a volatile memory (e.g., random access memory (RAM)), a non-volatile storage device (e.g., a disk), or in a distributed and/or redundant manner across multiple memories and/or storage devices. In an embodiment, patch database 102 is managed by and accessed via a corresponding database management system (DBMS), which is not shown in FIG. 1 for the sake of simplicity. Patch database 102 and the corresponding DBMS may be implemented on one or more computer systems, such as computer system 500 as described below in reference to FIG. 5. Patch database 102 and the corresponding DBMS may also be implemented on one or more servers of an enterprise network and/or a cloud computing network and accessed via a client computer system that is connected thereto, although these examples are not intended to be limiting.

Selector 104 may be implemented by processing logic that can comprise hardware (e.g., circuitry, dedicated logic, programmable logic, microcode, etc.), software (e.g., instructions executing on a processing device), or a combination thereof. In an embodiment, selector 104 is implemented in one or more software processes executing on one or more processor-based computer systems, such as computer system 500 as described below in reference to FIG. 5. Selector 104 may be configured to determine the top N or most-frequently used software components across a plurality of different computing systems, where N is any positive integer. For instance, selector 104 may be configured to query statistics database 120 that maintains a history of which software components are used the most across a plurality of different computing systems. Statistics database 120 may also indicate which software components are utilized on a given computing system, and further indicate the frequency at which such software components are utilized on the given computing system. Selector 104 may be configured to select patches (or patch notifications) from patch database 102 released for the top N or most-frequently used software components and provide such patches to pre-processor 106. In an embodiment, statistics database 120 is managed by and accessed via a corresponding DBMS, which is not shown in FIG. 1 for the sake of simplicity. Statistics database 120 and the corresponding DBMS may be implemented on one or more computer systems, such as computer system 500 as described below in reference to FIG. 5. Statistics database 120 and the corresponding DBMS may also be implemented on one or more servers of an enterprise network and/or a cloud computing network and accessed via a client computer system that is connected thereto, although these examples are not intended to be limiting.

Pre-processor 106 may be implemented by processing logic that can comprise hardware (e.g., circuitry, dedicated logic, programmable logic, microcode, etc.), software (e.g., instructions executing on a processing device), or a combination thereof. In an embodiment, pre-processor 106 is implemented in one or more software processes executing on one or more processor-based computer systems, such as computer system 500 as described below in reference to FIG. 5. Pre-processor 106 may be configured to pre-process text (e.g., ShortText) of each of the patches (or patch notifications) received from selector 104. Examples of pre-processing includes, but are not limited to, tokenization, stop word removal, stemming, lemmatization, certain character removal, etc. To perform tokenization, pre-processor 106 may convert a sequence of text into smaller units (i.e., tokens). Each token may correspond to one or more words, one or more phrases, one or more characters, etc., that serve as base units for further analysis. To perform stop word removal, pre-processor 106 may remove common words (e.g., the top N most common words with a frequency above a predetermined threshold (e.g., 1000), where N is any positive integer) that do not contribute significantly to the overall meaning or context of the text. To perform stemming and/or lemmatization, pre-processor 106 may convert inflected (or derived) words to their word stem, base, or root form, thereby standardizing the text and enabling more accurate analysis. To perform, certain character (e.g., unwanted character) removal, pre-processor 106 may remove punctuation and/or special characters (e.g., “!”, “?”, “$”, “%”, “/”, “\”, etc.) from the tokenized texts. In some embodiments, relevance checks may also be performed, where all of the processed words are checked for relevance by domain experts. The tokens resulting from pre-processor 106 for each patch may be provided to featurizer 108.

Featurizer 108 may be implemented by processing logic that can comprise hardware (e.g., circuitry, dedicated logic, programmable logic, microcode, etc.), software (e.g., instructions executing on a processing device), or a combination thereof. In an embodiment, featurizer 108 is implemented in one or more software processes executing on one or more processor-based computer systems, such as computer system 500 as described below in reference to FIG. 5. Featurizer 108 may be configured to generate representations (e.g., a feature vector) for the pre-processed tokens (also referred to as features). Representations generated by featurizer 108 may take any form, such as a numerical, visual, and/or textual representation, or may comprise any other suitable form. Featurizer 108 may operate in a number of ways to featurize pre-processed patches. For example and without limitation, featurizer 108 may featurizing pre-processed patches through, keyword featurization, semantic-based featurization, n-gram-term frequency-inverse document frequency (TF-IDF) featurization, and/or document-to-vector (doc2vec)-based featurization (where tokens are converted into numerical vectors). The representations generated for the pre-processed tokens are provided to clusterer 110.

Clusterer 110 may be implemented by processing logic that can comprise hardware (e.g., circuitry, dedicated logic, programmable logic, microcode, etc.), software (e.g., instructions executing on a processing device), or a combination thereof. In an embodiment, clusterer 110 is implemented in one or more software processes executing on one or more processor-based computer systems, such as computer system 500 as described below in reference to FIG. 5. Clusterer 110 may be configured to group patches (or patch notifications) deemed to be similar into respective clusters. For instance, clusterer 110 may analyze the representations of the tokens of the selected patches and determine the similarity of the tokens. Patches that include similar tokens are grouped into a particular cluster. Clusterer 110 may be configured to generate a cluster identifier or label for each cluster that uniquely identifies the cluster. Clusterer 110 may group patches into groups based on similarity utilizing various techniques, including, but not limited unsupervised learning models. An example of an unsupervised machine learning model that may be utilized is a k-means clustering-based unsupervised machine learning model, where TD-IDF feature representations are assigned to clusters based on a distance (e.g., a Euclidean distance) from a k number of clusters. It is noted that clusterer 110 may utilize other types of techniques and/or unsupervised machine learning models to group patches into different clusters based on similarity.

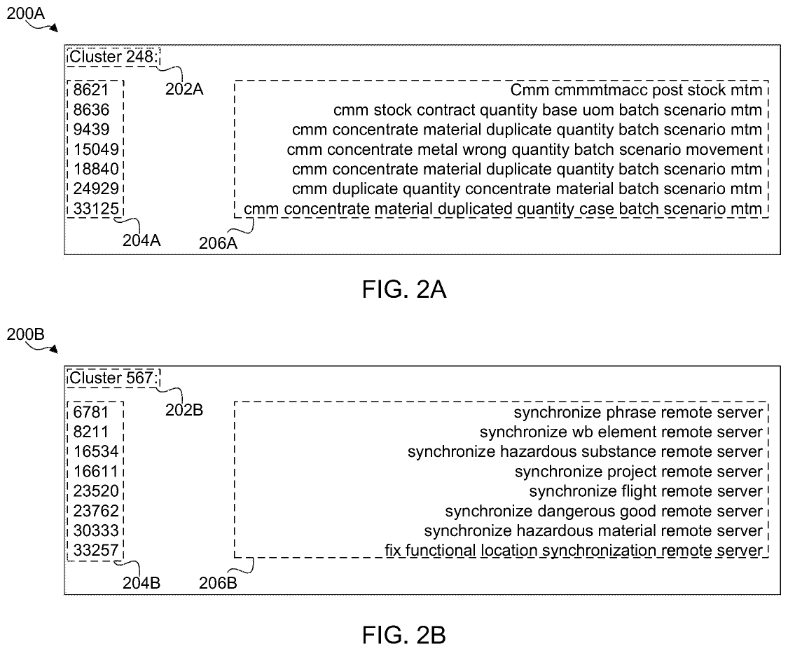

FIGS. 2A-2B depict example clusters of software patch notifications 200A and 200B, according to embodiments. Clusters 200A and 200B may be obtained by clusterer 110, as described above with reference to FIG. 1. Each of clusters 200A and 200B represent different clusters. It is noted that clusterer 110 may group patches into any number of clusters, including hundreds or thousands of different clusters. As shown in FIG. 2A, cluster 200A is identified by a cluster identifier or label 202A (e.g., cluster 248). Cluster 200A comprises seven different patches, each identified by a patch identifier 204A (e.g., patch identifiers 8621, 8636, 9439, 15049, 18840, 24929, and 33125. However, it is noted that a cluster may comprise any number of patches (or patch notifications). The tokens deemed to be similar for such patches are shown as tokens 206A. As shown in FIG. 2B, cluster 200B is identified by a cluster identifier or label 202B (e.g., cluster 567). Cluster 200B comprises eight different patches, each identified by a patch identifier 204B (e.g., patch identifiers 6781, 8211, 16534, 16611, 23520, 23762, 30333, and 33257. The tokens deemed to be similar for such patches are shown as tokens 206B.

Referring again to FIG. 1, an indication of each of the clusters determined by clusters 110 are provided to training data generator 112. Training data generator 112 may be implemented by processing logic that can comprise hardware (e.g., circuitry, dedicated logic, programmable logic, microcode, etc.), software (e.g., instructions executing on a processing device), or a combination thereof. In an embodiment, training data generator 112 is implemented in one or more software processes executing on one or more processor-based computer systems, such as computer system 500 as described below in reference to FIG. 5. Training data generator 112 may comprise a semi-supervised machine learning model configured to analyze each of the clusters and the cluster identifiers or labels of such clusters and learn how software patch notifications are grouped together based on similarity. The semi-supervised machine learning model may then analyze additional software patch notifications in patch database 102 that were not previously selected by selector 104 and automatically label or classify such software patch notifications as being part of a particular cluster. This advantageously generates a robust dataset (shown as training data 114) utilized to train a supervised machine learning algorithm.

Training data 114 generated by training data generator 112 may be stored in a volatile memory (e.g., RAM), a non-volatile storage device (e.g., a disk), or in a distributed and/or redundant manner across multiple memories and/or storage devices. In an embodiment, training data 114 is stored in one or more memories or storage devices that are accessible by ML model trainer 116.

ML model trainer 116 may be implemented by processing logic that can comprise hardware (e.g., circuitry, dedicated logic, programmable logic, microcode, etc.), software (e.g., instructions executing on a processing device), or a combination thereof. In an embodiment, ML model trainer 116 is implemented in one or more software processes executing on one or more processor-based computer systems, such as computer system 500 as described below in reference to FIG. 5. ML model trainer 116 is configured to use training data 114 to train an ML algorithm. The ML algorithm generates a ML model configured to predict one or more computing systems that should apply a particular software patch. For instance, ML model trainer 116 may receive indications of which software patches were installed on various computing systems and/or the frequency of usage of the system components to which the software patches apply. The indications may be received from statistics database 120. ML model trainer 116 may input training data 114 and the indications received from statistics database 120 to an ML algorithm that learns which types of software patches are installed for different computing systems. The trained ML model is represented as ML model 118 in FIG. 1.

In an embodiment, ML model 118 comprises a supervised ML classifier. In further accordance with such an embodiment, ML model 118 may comprise a generalized linear or multi-model regression model supervised ML classifier. However, these examples are not intended to be limiting and ML model 118 may comprise a variety of other ML model or ML classifier types. For instance, ML model may comprise one or more of a recurrent neural network (RNN)-based ML model, a long short-term memory (LSTM)-based ML model, an attention mechanism-based ML model, a transformer-based model, etc. The type of model used for ML model 118 may be selected based on its performance metrics and requirements for the particular task at hand. The selected model may be trained using various techniques including, but not limited to backpropagation through time and the Adaptive Moment Estimation (Adam) optimization algorithm.

Once ML model 118 has been trained by ML model trainer 116, ML model 118 can then be used to predict whether a particular software patch notification 124 (e.g., software patch notifications stored in patch database 102 or a new software patch notification) is to be provided to a particular computing system.

For example, software patch notification 124 may be obtained by patch notification provider 128. Patch notification provider 128 may be implemented by processing logic that can comprise hardware (e.g., circuitry, dedicated logic, programmable logic, microcode, etc.), software (e.g., instructions executing on a processing device), or a combination thereof. In an embodiment, software patch notification provider 128 is implemented in one or more software processes executing on one or more processor-based computer systems, such as computer system 500 as described below in reference to FIG. 5.

Patch notification provider 128 may pre-process software patch notification 124 in a similar manner as described above with reference to pre-processor 106. Patch notification provider 128 may also generate a representation of software patch notification 128 in a similar manner as described above with reference to featurizer 108. Patch notification provider 128 may provide the representation of software patch notification 124 as an input to ML model 118. ML model 118 may analyze the representation of patch notification 124 and outputs one or more predictions 126 as to which computing system(s) are to receive the software patch notification. ML model 118 may also recommend a particular software patch notification to other computing system(s) that are similarly-configured.

In an embodiment, ML model 118 also outputs a probability associated with each of prediction(s) 126. Such a probability may represent a degree of confidence associated with the corresponding prediction.

Software patch recommender 130 may be implemented by processing logic that can comprise hardware (e.g., circuitry, dedicated logic, programmable logic, microcode, etc.), software (e.g., instructions executing on a processing device), or a combination thereof. In an embodiment, software patch recommender 130 is implemented in one or more software processes executing on one or more processor-based computer systems, such as computer system 500 as described below in reference to FIG. 5. Software patch recommender 130 may provide one or more recommendations 132 to apply software patch(es) to one or more computing systems. In an embodiment, software patch recommender 130 is configured to determine whether prediction(s) 126 meet a particular threshold. The computing system(s) having a prediction probability that meets the particular threshold may be provided recommendation(s) 132. Recommendations(s) 132 may be presented on a user interface associated with the computing system(s). A user may select recommendation(s) 132 to install the corresponding software patch on the computing system. Alternatively, the software patch may be installed automatically on the computing system upon receiving recommendation(s) 132.

In an embodiment, system 100 may comprise a generative artificial intelligence (AI)-based model configured to generate a knowledge graph representing various relationships between different computing systems. For instance, the knowledge graph may associate various computing systems having the same or similar components, the same or similar software patches, etc., for example via an edge that couples such components.

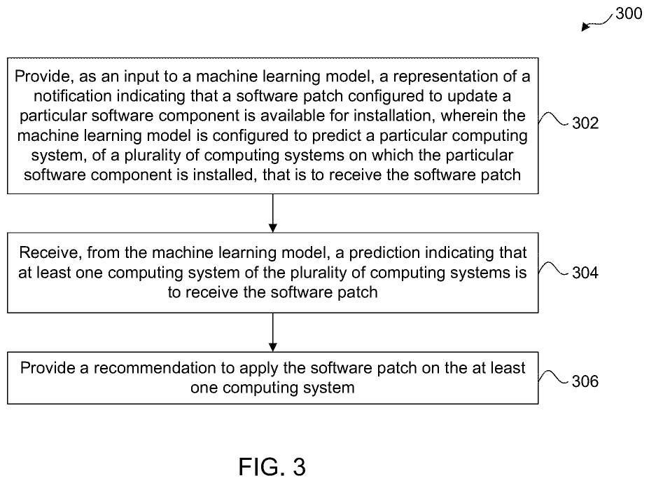

FIG. 3 is a flowchart of a method 300 for recommending a software patch notification for a computing system, according to an embodiment. Method 300 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 3, as will be understood by a person of ordinary skill in the art.

Method 300 shall be described with reference to FIG. 1. However, method 300 is not limited to that example embodiment.

In 302, patch notification provider 128 may provide, as an input to ML model 118, a representation of a notification (e.g., software patch notification 124) indicating that a software patch configured to update a particular software component is available for installation, wherein ML model 118 is configured to predict a particular computing system, of a plurality of computing systems on which the particular software component is installed, that is to receive the software patch.

In 304, software patch recommender 130 may receive, from ML model 118, a prediction 126 indicating that at least one computing system of the plurality of computing systems is to receive the software patch.

In 306, software patch recommender 130 may provide a recommendation 132 to apply the software patch on the at least one computing system.

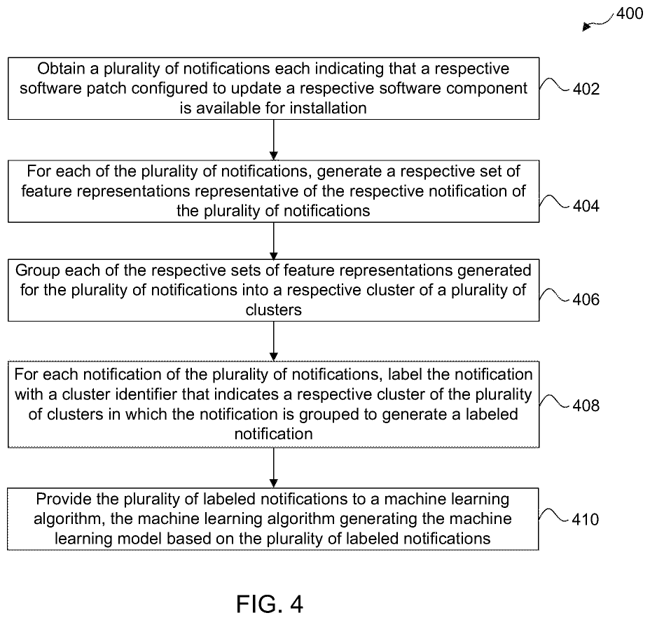

FIG. 4 is a flowchart for a method 400 for generating an ML model, according to an embodiment. Method 400 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 4, as will be understood by a person of ordinary skill in the art.

Method 400 shall be described with reference to FIG. 1. However, method 400 is not limited to that example embodiment.

In 402, selector 104 may obtain a plurality of notifications (e.g., from patch database 102) each indicating that a respective software patch configured to update a respective software component is available for installation. In an embodiment, selector 104 may determine an N most frequently used software components, wherein N is any positive integer, and wherein the plurality of notifications are associated with the N most frequently used software components. For instance, selector 104 may query statistics database 120 to determine the N most frequently used software components. Selector 104 may then query patch database 102 to obtain notifications that are associated with the N most frequently used software components.

In 404, featurizer 108 may, for each of the plurality of notifications, generate a respective set of feature representations representative of the respective notification of the plurality of notifications. In an embodiment, to generate the respective set of features representations representative of the respective notification of the plurality of notifications, pre-processor 106 may pre-process text included in the respective notification. Featurizer 108 may generate the respective set of feature representations based on the pre-processed text.

In an embodiment, pre-processing the text includes at least one of tokenization of the text included in the respective notification, stop word removal of the text included in the respective notification, stemming the text included in the respective notification, lemmatization of the text included in the respective notification, or unwanted character removal of the text included in the respective notification.

In 406, clusterer 110 may group each of the respective sets of feature representations generated for the plurality of notifications into a respective cluster of a plurality of clusters. In an embodiment, the grouping may be implemented by an unsupervised machine learning model.

In 408, training data generator 112 may, for each notification of the plurality of notifications, may label the notification with a cluster identifier that indicates a respective cluster of the plurality of clusters in which the notification is grouped to generate a labeled notification. In an embodiment, the labeling may be implemented by a semi-supervised machine learning model.

In 410, training data generator 112 may provide the plurality of labeled notifications to a machine learning algorithm (e.g., ML model trainer 116), the machine learning algorithm generating ML model 118 based on the plurality of labeled notifications. In an embodiment, the machine learning algorithm is a supervised machine learning algorithm.

Various embodiments may be implemented, for example, using one or more well-known computer systems, such as computer system 500 shown in FIG. 5. One or more computer systems 500 may be used, for example, to implement any of the embodiments discussed herein, as well as combinations and sub-combinations thereof.

Computer system 500 may include one or more processors (also called central processing units, or CPUs), such as a processor 504. Processor 504 may be connected to a communication infrastructure or bus 506.

Computer system 500 may also include user input/output device(s) 503, such as monitors, keyboards, pointing devices, etc., which may communicate with communication infrastructure 506 through user input/output interface(s) 502.

One or more of processors 504 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 500 may also include a main or primary memory 508, such as random access memory (RAM). Main memory 508 may include one or more levels of cache. Main memory 508 may have stored therein control logic (i.e., computer software) and/or data.

Computer system 500 may also include one or more secondary storage devices or memory 510. Secondary memory 510 may include, for example, a hard disk drive 512 and/or a removable storage device or drive 514. Removable storage drive 514 may be a floppy disk drive, a magnetic tape drive, a compact disk drive, an optical storage device, tape backup device, and/or any other storage device/drive.

Removable storage drive 514 may interact with a removable storage unit 518. Removable storage unit 518 may include a computer usable or readable storage device having stored thereon computer software (control logic) and/or data. Removable storage unit 518 may be a floppy disk, magnetic tape, compact disk, DVD, optical storage disk, and/any other computer data storage device. Removable storage drive 514 may read from and/or write to removable storage unit 518.

Secondary memory 510 may include other means, devices, components, instrumentalities or other approaches for allowing computer programs and/or other instructions and/or data to be accessed by computer system 500. Such means, devices, components, instrumentalities or other approaches may include, for example, a removable storage unit 522 and an interface 520. Examples of removable storage unit 522 and interface 520 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 500 may further include a communication or network interface 524. Communication interface 524 may enable computer system 500 to communicate and interact with any combination of external devices, external networks, external entities, etc. (individually and collectively referenced by reference number 528). For example, communication interface 524 may allow computer system 500 to communicate with external or remote devices 528 over communications path 526, which may be wired and/or wireless (or a combination thereof), and which may include any combination of LANs, WANs, the Internet, etc. Control logic and/or data may be transmitted to and from computer system 500 via communication path 526.

Computer system 500 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 500 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 500 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 500, main memory 508, secondary memory 510, and removable storage units 518 and 522, as well as tangible articles of manufacture embodying any combination of the foregoing. Such control logic, when executed by one or more data processing devices (such as computer system 500), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 5. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or variable, but every embodiment can not necessarily include the particular feature, structure, or variable. Moreover, such phrases are not necessarily referring to the same embodiment. Further, when a particular feature, structure, or variable is described in connection with an embodiment, it would be within the knowledge of persons skilled in the relevant art(s) to incorporate such feature, structure, or variable into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A computer-implemented method, comprising;
providing, as an input to a machine learning model, a representation of a notification indicating that a software patch configured to update a particular software component is available for installation, wherein the machine learning model is configured to predict a particular computing system, of a plurality of computing systems on which the particular software component is installed, that is to receive the software patch;
receiving, from the machine learning model, a prediction indicating that at least one computing system of the plurality of computing systems is to receive the software patch; and
providing a recommendation to apply the software patch on the at least one computing system.

2. The computer-implemented method of claim 1, wherein the machine learning model is generated by:
obtaining a plurality of notifications each indicating that a respective software patch configured to update a respective software component is available for installation;
for each of the plurality of notifications, generating a respective set of feature representations representative of the respective notification of the plurality of notifications;
grouping each of the respective sets of feature representations generated for the plurality of notifications into a respective cluster of a plurality of clusters;
for each notification of the plurality of notifications,
labeling the notification with a cluster identifier that indicates a respective cluster of the plurality of clusters in which the notification is grouped to generate a labeled notification; and
providing the plurality of labeled notifications to a machine learning algorithm, the machine learning algorithm generating the machine learning model based on the plurality of labeled notifications.

3. The computer-implemented method of claim 2, wherein obtaining the plurality of notifications comprises:
determining an N most frequently used software components, wherein N is any positive integer, and wherein the plurality of notifications are associated with the N most frequently used software components.

4. The computer-implemented method of claim 2, wherein generating the respective set of features representations representative of the respective notification of the plurality of notifications comprises:
pre-processing text included in the respective notification; and
generating the respective set of feature representations based on the pre-processed text.

5. The computer-implemented method of claim 4, wherein pre-processing the text comprises at least one of:
tokenization of the text included in the respective notification;
stop word removal of the text included in the respective notification;
stemming the text included in the respective notification;
lemmatization of the text included in the respective notification; or
unwanted character removal of the text included in the respective notification.

6. The computer-implemented method of claim 2, wherein said grouping is implemented by an unsupervised machine learning model.

7. The computer-implemented method of claim 2, wherein said labeling is implemented by a semi-supervised machine learning model.

8. The computer-implemented method of claim 2, wherein the machine learning algorithm is a supervised machine learning algorithm.

9. A system, comprising:
a memory; and
at least one processor coupled to the memory and configured to:
provide, as an input to a machine learning model, a representation of a notification indicating that a software patch configured to update a particular software component is available for installation, wherein the machine learning model is configured to predict a particular computing system, of a plurality of computing systems on which the particular software component is installed, that is to receive the software patch;
receive, from the machine learning model, a prediction indicating that at least one computing system of the plurality of computing systems is to receive the software patch; and
provide a recommendation to apply the software patch on the at least one computing system.

10. The system of claim 9, wherein, to generate the machine learning model, the at least one processor is configured to:
obtain a plurality of notifications each indicating that a respective software patch configured to update a respective software component is available for installation;
for each of the plurality of notifications, generate a respective set of feature representations representative of the respective notification of the plurality of notifications;
group each of the respective sets of feature representations generated for the plurality of notifications into a respective cluster of a plurality of clusters;
for each notification of the plurality of notifications,
label the notification with a cluster identifier that indicates a respective cluster of the plurality of clusters in which the notification is grouped to generate a labeled notification; and
provide the plurality of labeled notifications to a machine learning algorithm, the machine learning algorithm generating the machine learning model based on the plurality of labeled notifications.

11. The system of claim 10, wherein, to obtaining the plurality of notifications, the at least one processor is configured to:
determine an N most frequently used software components, wherein N is any positive integer, and wherein the plurality of notifications are associated with the N most frequently used software components.

12. The system of claim 10, wherein, to generate the respective set of features representations representative of the respective notification of the plurality of notifications, the at least one processor is configured to:
pre-process text included in the respective notification; and
generate the respective set of feature representations based on the pre-processed text.

13. The system of claim 12, wherein, to pre-process the text, the at least one processor is configured to perform at least one of:
tokenize the text included in the respective notification;
remove stop words from the text included in the respective notification;
stem the text included in the respective notification;
lemmatize the text included in the respective notification; or
remove unwanted characters from the text included in the respective notification.

14. The system of claim 10, wherein an unsupervised machine learning model is utilized to group each of the respective sets of feature representations generated for the plurality of notifications into a respective cluster of a plurality of clusters.

15. The system of claim 10, wherein a semi-supervised machine learning model is utilized to label the notification with a cluster identifier that indicates a respective cluster of the plurality of clusters in which the notification is grouped to generate a labeled notification.

16. The system of claim 10, wherein the machine learning algorithm is a supervised machine learning algorithm.

17. A non-transitory computer-readable device having instructions stored thereon that, when executed by at least one computing device, cause the at least one computing device to perform operations comprising:
providing, as an input to a machine learning model, a representation of a notification indicating that a software patch configured to update a particular software component is available for installation, wherein the machine learning model is configured to predict a particular computing system, of a plurality of computing systems on which the particular software component is installed, that is to receive the software patch;
receiving, from the machine learning model, a prediction indicating that at least one computing system of the plurality of computing systems is to receive the software patch; and
providing a recommendation to apply the software patch on the at least one computing system.

18. The non-transitory computer-readable device of claim 17, wherein the machine learning model is generated by:
obtaining a plurality of notifications each indicating that a respective software patch configured to update a respective software component is available for installation;
for each of the plurality of notifications, generating a respective set of feature representations representative of the respective notification of the plurality of notifications;
grouping each of the respective sets of feature representations generated for the plurality of notifications into a respective cluster of a plurality of clusters;
for each notification of the plurality of notifications,
labeling the notification with a cluster identifier that indicates a respective cluster of the plurality of clusters in which the notification is grouped to generate a labeled notification; and
providing the plurality of labeled notifications to a machine learning algorithm, the machine learning algorithm generating the machine learning model based on the plurality of labeled notifications.

19. The non-transitory computer-readable device of claim 18, wherein obtaining the plurality of notifications comprises:
determining an N most frequently used software components, wherein N is any positive integer, and wherein the plurality of notifications are associated with the N most frequently used software components.

20. The non-transitory computer-readable device of claim 18, wherein generating the respective set of features representations representative of the respective notification of the plurality of notifications comprises:
pre-processing text included in the respective notification; and
generating the respective set of feature representations based on the pre-processed text.
